(19) United States
(12) Patent Application Publication
(10) Pub. No.: US 2026/0139997 A1
(43) Pub. Date: May 21, 2026

(54) Wireless Thermometer and Method Using Thereof

(71) Applicant: Zheng Liu, Guangzhou City (CN)

(72) Inventor: Zheng Liu, Guangzhou City (CN)

(21) Appl. No.: 19/027,662

(22) Filed: Jan. 17, 2025

Related U.S. Application Data
(60) Provisional application No. 63/723,156, filed on Nov. 21, 2024.

(51) Int. Cl. G01K 1/024; G01K 1/02; G01K 1/04; G01K 1/20; G01K 3/14

(52) U.S. Cl. CPC G01K 1/024; G01K 1/026; G01K 1/045; G01K 1/20; G01K 3/14; G01K 2207/06; G01K 2213/00

(57) ABSTRACT

This invention relates to a wireless thermometer featuring a trident probe configuration, optimized for monitoring and controlling food temperatures during cooking. The central probe extends deeper, while two shorter side probes measure temperature at the edges, providing a comprehensive thermal profile. Temperature data is transmitted to a connected electronic device, where AI algorithms process temperature trends and food images to suggest cooking adjustments. These adjustments include precise grill height and power settings, enabling users to achieve consistent and well-monitored cooking results. The thermometer's robust data transmission capability and real-time feedback improve cooking efficiency and accuracy.

### CROSS-REFERENCE TO RELATED APPLICATIONS

This application claims priority to U.S. Provisional Application No. 63/723,156, filed on Nov. 21, 2024, the disclosure of which is incorporated herein by reference in its entirety.

### FIELD OF THE INVENTION

The present disclosure relates to the technical field of temperature sensing and monitoring devices and, more specifically, to a wireless meat temperature probe designed to address uneven cooking challenges during the preparation of food items such as barbecue, braised, or roasted meats.

### BACKGROUND OF THE INVENTION

Wireless meat thermometers have been widely used to monitor the internal temperature of meat during cooking. These devices allow users to track internal temperature and estimate when meat will reach a desired level of doneness. However, one major limitation is the inability to measure the temperature at multiple depths within the meat simultaneously, which often results in uneven cooking. The edges of the meat, being directly exposed to heat, tend to cook faster than the center, leading to a discrepancy between the external and internal temperatures.

Current wireless meat thermometers generally fall into two categories:
1) Devices with a sensor probe wired to an external processing unit that calculates and transmits temperature data to a smartphone or wireless device.
2) Devices with fully embedded electronics, including a battery, Micro-controller Unit (MCU), and wireless transceiver, that wirelessly transmit data from the sensor to an external device.

However, both types of systems are limited in their ability to accurately assess cooking progress across multiple regions of the meat, often requiring additional monitoring equipment to track external cooking temperature, making the process cumbersome. The center-edge temperature differential further complicates this, affecting cooking outcomes and often resulting in under-cooked or overcooked sections.

### SUMMARY OF THE INVENTION

The present disclosure relates to a wireless meat thermometer that utilizes a novel “Trident” shaped probe arrangement to address the challenge of uneven cooking caused by temperature differentials between the center and edges of food during cooking. The thermometer includes at least two probes of different lengths, with two shorter probes positioned on either side of a longer central probe. This configuration allows for comprehensive temperature monitoring at different depths within the food, ensuring accurate measurement of both external and internal cooking temperatures.

The system also includes a control module to process temperature data and a wireless communication module that transmits the information to an external device. In addition, a photo integration module captures images of the food and the positioning of the probes, while a processor analyzes the real-time temperature data in conjunction with the visual information. This advanced functionality provides users with real-time feedback on cooking adjustments to achieve optimal results.

The present disclosure provides an advanced wireless thermometer for measuring food temperatures during cooking, addressing the challenges of uneven heating between the center and the edges of the food. The thermometer is equipped with a minimum of two probes of different lengths, allowing it to measure temperatures at multiple depths within the food item. This innovative probe configuration is designed to ensure accurate temperature monitoring at both the core and surface levels, offering users a more precise understanding of the cooking process.

A primary feature of this thermometer is the ability to wirelessly transmit temperature data via a wireless communication module to an external device, such as a smartphone or tablet. This data transmission occurs in real time, allowing the user to monitor the cooking progress remotely without the need for physical connectivity to the probe or a separate processing unit. The wireless aspect provides convenience and mobility, particularly for grilling, roasting, or barbecuing where multiple heat sources and temperature variables are at play.

Additionally, the present disclosure integrates a photo module that captures images of the food and the placement of the probes within it. This photo integration module works in conjunction with the temperature data to provide a visual representation of the cooking process. By capturing images of the probe positioning and the food's appearance, the system allows for a deeper analysis of how heat is distributed throughout the food.

At the heart of this system is a processor that not only collects and analyzes temperature data from the probes but also processes the captured images. This processor is configured to correlate the visual data with the temperature profiles, enabling real-time feedback and suggestions to the user. The system's analysis considers the food's internal and external temperature changes and provides recommendations for adjusting cooking times, changing the position of the food on the heat source, or repositioning the probes to achieve more uniform cooking.

This combination of temperature and image data allows for an unprecedented level of control over the cooking process, particularly for meat and other food items where precise internal temperatures are critical for safety and flavor. Furthermore, by providing real-time feedback and suggestions, the system mitigates the common issue of overcooking or under-cooking different sections of the meat due to uneven heat distribution.

In addition to the temperature and photo features, the thermometer can be further enhanced with machine learning algorithms. These algorithms can learn from past cooking sessions, analyzing historical data and adapting the feedback to optimize future cooking results. Over time, the system can predict the ideal cooking times and temperature profiles for different types of food, improving cooking consistency and user experience.

The present disclosure also incorporates a user-friendly interface on the external device, where the captured images and temperature data are visually displayed. The interface may feature alerts and notifications to inform the user when significant temperature differences are detected between the center and the edges of the food, ensuring that the user takes necessary corrective actions to avoid uneven cooking. The integration of wireless technology, multi-point temperature monitoring, and real-time image analysis makes this thermometer a comprehensive tool for improving cooking precision and overall food quality.

In summary, the present disclosure overcomes the limitations of traditional single-point meat thermometers by providing a multi-depth, wireless, and image-integrated solution for monitoring food during cooking. This innovative approach ensures even cooking, improved flavor, and better control over the cooking process, offering users both convenience and enhanced culinary outcomes.

### BRIEF DESCRIPTION OF DRAWINGS

The present invention and its advantages as described according to the drawings are given as exemplary embodiments and detailed description of the specific embodiments shown in the attached drawings shall not be interpreted as limiting. In the drawings:

FIG. 1 illustrates a wireless thermometer according to a preferred embodiment.

FIG. 2 shows the wireless thermometer of FIG. 1 being inserted into a food item in accordance with the preferred embodiment of the present invention.

FIG. 3 shows wireless communications between the wireless food thermometer and a portable electronic device according to an embodiment.

### DETAILED DESCRIPTION OF THE INVENTION

The disclosure may be more completely understood in consideration of the following detailed description of various embodiments of the disclosure in connection with the accompanying drawings. The following description is based on the illustrated specific embodiments of the present invention, and should not be regarded as limiting other specific embodiments of the present invention that are not described in detail herein.

The word “embodiment” used in this specification means serving as an example, example, or illustration. In addition, the article “a” used in this specification and appended claims can generally be construed as meaning “one or more” unless specified otherwise or clearly directed to the singular form from the context.

In the description of the present invention, it should be understood that the terms “center”, “longitudinal”, “transverse”, “length”, “width”, “thickness”, “upper”, “lower”, “front”, “Back”, “Left”, “Right”, “Vertical”, “Horizontal”, “Top”, “Bottom”, “Inner”, “Outer”, “Clockwise”, “Counterclockwise” and other directions are positional relationships based on the position or positional relationship shown in the drawings, and is only for the convenience of describing the present invention and simplifying the description, and does not indicate or imply that the pointed device or element must have a specific orientation, be constructed and operated in a specific orientation, Therefore, it cannot be understood as a limitation to the present invention.

In the description of the present invention, it should be noted that the terms “set” and “connected” should be understood in a broad sense unless otherwise clearly specified and limited. For example, they can be fixed or detachable. Connected or integrally connected; it can be mechanically connected, or it can be electrically connected or can communicate with each other; it can be directly connected, or indirectly connected through an intermediate medium, it can be the internal communication of two components or the interaction of two components in relationship. For those of ordinary skill in the art, the specific meaning of the above-mentioned terms in the present invention can be understood according to specific circumstances.

In addition, unless expressly stipulated and defined otherwise, the “above” or “below” of the first feature of the second feature may include the first and second features in direct contact, or the first and second features are not in direct contact but through the contact of other features between them. Moreover, “above” the second feature of the first feature includes the first feature being directly above and obliquely above the second feature, or indicating that the first feature is higher in level than the second feature. The “below” the first feature of the second feature includes the first feature directly below and obliquely below the second feature, or that the level of the first feature is lower than the second feature.

The following disclosure provides many different embodiments or examples for realizing different structures of the present invention. In order to simplify the disclosure of the present invention, the components and settings of specific examples are described below. Of course, they are only examples, and the purpose is not to limit the present invention. In addition, the present invention may repeat reference numerals and/or reference letters in different examples, and this repetition is for the purpose of simplification and clarity, and does not indicate the relationship between the various embodiments and/or settings discussed. In addition, the present invention provides examples of various specific processes and materials, but those of ordinary skill in the art may be aware of the application of other processes and/or the use of other materials.

The following detailed description provides exemplary embodiments of the present disclosure, a wireless food thermometer equipped with multiple probes of different lengths for measuring food temperatures during cooking. The present disclosure is particularly useful for accurately monitoring both the internal and external temperatures of food, such as meat, which often experiences uneven cooking due to differences in heat exposure between the surface and the core.

The food thermometer includes two or more temperature probes, each of a different length, designed to measure the temperature at distinct depths of the food. The present disclosure allows the user to monitor the external, near-surface temperature and the deeper internal temperature simultaneously, thereby overcoming common issues associated with uneven cooking. The thermometer is configured to be wireless and is equipped with a communication module that wirelessly transmits real-time temperature data to an external device such as a smartphone or tablet for display and analysis. A photo integration module is also incorporated to capture images of the food and the placement of the probes within it. This allows the user to visually track the cooking progress in conjunction with the temperature data. A processor analyzes both the temperature data and the images to provide real-time feedback and recommendations regarding the cooking process, including possible adjustments to heat, timing, or probe placement.

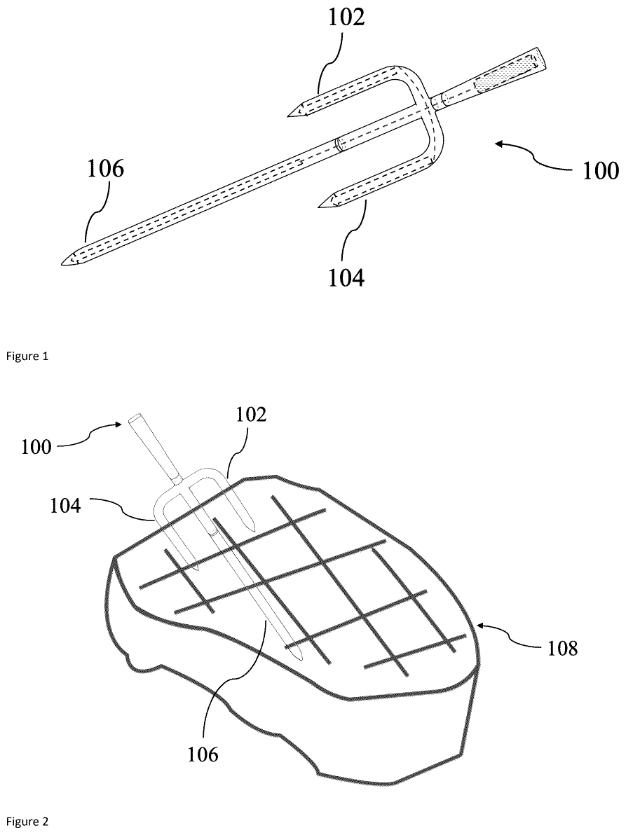

Referring to FIGS. 1-3 in the drawing, in a preferred embodiment, the food thermometer system (referred to as thermometer 100) utilizes a Trident probe structure to enhance precision in monitoring the internal temperature of food during cooking. This unique structure comprises three distinct probes: a long central probe for measuring the internal core temperature of the food, and two shorter probes symmetrically positioned on either side of the central probe, which are used for measuring the temperature of the food's outer edges. This arrangement ensures a comprehensive measurement of temperature gradients throughout the food, enabling optimal cooking control and real-time feedback.

### Trident Probe Structure and Functionality

The thermometer 100 is divided into three main portions, each serving specific functions during cooking:
1) First Probe 106: The first probe 106, located at the tip of the thermometer, is the long central probe. It is configured to penetrate deeply into the core of the food item, ensuring accurate measurement of the internal temperature at its deepest point. This probe is especially useful for monitoring the center temperature of large or thick cuts of meat, ensuring proper doneness without overcooking the exterior.
2) Second and Third Probes 104, 102: The second probe 104 and the third probe 102 are the two shorter side probes, symmetrically positioned on either side of the first probe 106. Together with the first probe 106, they form the Trident structure. These shorter probes are designed specifically to measure the temperatures near the edges or surface regions of the food, providing data on how heat is penetrating the outer layers. This is particularly valuable for monitoring how the outer portions of the food are cooking in relation to its core, allowing for real-time adjustments if the surface is overcooking while the inside is still raw.

As discussed in more detail below, the first probe 106 houses thermally sensitive electronics, including thermal sensors and a solid-state battery. The first probe is designed to be inserted into the food item (e.g., steak), where the food insulates the sensitive electronics from the high ambient temperatures (e.g., over 230° C.). The internal temperature of the food, usually below 77° C., protects components that could degrade at temperatures above 100° C., such as a thin film lithium battery.

Thermal Sensors: The thermal sensor embedded in the first probe 106 measures the core temperature of the food. This sensor provides accurate readings of the internal temperature, ensuring that the thermally sensitive electronics are well-insulated by the food itself.

The second probe 104 and third probe 102, which comprise the two shorter probes in the Trident structure, are symmetrically positioned alongside the central probe for detecting edge temperatures. This configuration enables comprehensive temperature monitoring across different sections of the food, including the core and edges.

Edge Temperature Sensors: The shorter second and third probes (104, 102) are positioned near the food's surface. These probes detect the temperature at the food's outer layers or edges, providing valuable insights into how the surface is cooking relative to the core. This is especially useful for meats where the exterior may cook more quickly than the interior.

Ambient Temperature Sensors: The ambient temperature sensors are strategically located in the handle part of the thermometer, separate from the probes inserted into the food. This placement allows the sensors to monitor the ambient cooking environment, providing data on the external heat near the food without being affected by the food itself. This design enhances the sensor's accuracy in measuring the cooking vessel's ambient temperature.

### Dual Thermal Sensors for Enhanced Accuracy

The system utilizes distinct types of sensors to capture both food and ambient temperatures:
1) Core Temperature Sensor: Located primarily in the first probe 106, the thermal sensor is designed to measure the internal temperature of the food. It is optimized for the temperature range typical of cooking (e.g., 20° C. to 100° C.), ensuring accurate readings of the food's doneness.
2) Edge Temperature Sensors: The two shorter probes in the second and third probes (104, 102) measure the temperature near the surface of the food. These sensors help track the progression of cooking at the edges, where the heat from the cooking vessel first contacts the food.
3) Ambient Temperature Sensor: The ambient sensor, positioned in the handle part of the thermometer, is designed to endure the higher temperatures of the cooking environment (e.g., over 230° C.). This sensor tracks the external conditions in the cooking vessel, helping adjust for fluctuations in ambient heat near the food.

One of the core innovations of this system is its ability to use images of the food and the trident Probe inserted into the food to analyze critical physical properties before and during cooking:
1) Pre-Cooking Image Capture: Before cooking begins, the user captures high-resolution images of the food and the placement of the trident probe. These images provide important visual data that complement the temperature readings.
2) Weight, Volume, and Thickness Estimation: Using advanced image processing algorithms, the system can estimate the weight, volume, and thickness of the food. These measurements, combined with temperature data, allow the system to make more accurate cooking predictions. For example, knowing the food's thickness helps the system adjust for how long heat will take to penetrate the center.
3) Area and Shape Analysis: The system also analyzes the surface area and shape of the food. By mapping out these dimensions, the AI (Artificial intelligence) can adjust its cooking recommendations based on how different regions of the food are expected to heat up at different rates.
4) Specific Heat Capacity in Regions: The image analysis can further assess variations in specific heat capacity across different regions of the food. For instance, fat, muscle, and bone all have different thermal properties, which the system accounts for in its temperature predictions. This allows for region-specific cooking, where the system optimizes heat application based on the food's internal composition.

### Real-Time Visual Feedback based on Temperature Data and Image Analysis

The system uses the data from the probes and the image analysis to provide real-time visual feedback through a simulation model:
1) Simulation Model of Cooking Progress: The temperature data from the Trident probes and the image-based measurements are used to generate a real-time simulation model of the cooking process. This simulation gives the user a visual representation of how the heat is being distributed throughout the food, showing detailed progress in both the core and edges.
2) Dynamic Updates Based on Temperature and Visual Data: As cooking progresses, the simulation is updated in real time, reflecting the current temperature at multiple points within the food and the estimated cooking state of different regions. This allows the user to visually track which parts of the food are reaching the desired doneness.

### Ai-Driven Cooking Prediction

The system also incorporates AI-driven cooking prediction, offering users smart recommendations based on a combination of temperature data, image analysis, and the simulation model:
1) AI Prediction of Cooking Time: By analyzing the temperature data from the Trident probes and the physical properties of the food derived from image analysis, the AI can predict the optimal cooking time for different types of food. The AI continuously adjusts its predictions based on real-time data, ensuring accuracy throughout the cooking process.
2) Visual Feedback and AI Suggestions: The AI uses the visual feedback provided by the simulation model to offer recommendations on adjusting cooking times, flipping the food, or changing the temperature. These suggestions are based on the specific heat properties, shape, and thickness of the food as identified by the image analysis.
3) AI Learning and Adaptation: Over time, the AI can adapt to the user's preferences by learning from previous cooking sessions, refining its predictions, and providing more personalized recommendations for different types of food.

### AI-Controlled Adjustment of Cooking Parameters

The system incorporates AI algorithms that analyze the cooking data and images to optimize the cooking process by making real-time adjustments to key parameters:
1) Angle and Height Adjustments: The AI can adjust the angle and height of the grill surface based on how heat is distributed across the food. For example, if certain areas of the food are heating more rapidly (as detected by the side probes or camera analysis), the AI may lower or raise the grill height or tilt the surface to balance the heat distribution, ensuring uniform cooking across the entire food item.
2) Grill Power Control: Based on the temperature data from the Trident probes and the temperature change curves, the AI can also adjust the power output of the grill. This might involve increasing the heat in certain areas of the grill to ensure faster cooking or reducing the power to prevent overcooking specific regions.
3) Food Geometry Analysis: The camera system captures images of the food before and during cooking. These images allow the AI to analyze the geometry of the food, including its height, thickness, and surface area. The AI cross-references this information with the temperature data to fine-tune its adjustments to the grill's settings.
4) Temperature Change Curves: As the cooking progresses, the system continuously monitors the temperature curves for each probe. The AI uses these curves to predict how quickly different parts of the food are heating and adjusts the grill's settings to maintain optimal cooking conditions.

### Dynamic AI Predictions for Cooking Completion

The AI system can predict the optimal time to adjust the grill based on the current cooking status and future heat distribution patterns. These adjustments are made automatically and are designed to:
1) Balance Heat Distribution: By adjusting the grill's angle and height, the system ensures that heat is evenly distributed across the food, accounting for differences in thickness or shape that may cause uneven cooking.
2) Adjust Heat Power: The AI fine-tunes the grill's power to match the food's specific heat capacity, ensuring that each region of the food (whether fat, muscle, or bone) is heated appropriately to achieve a perfectly cooked result.

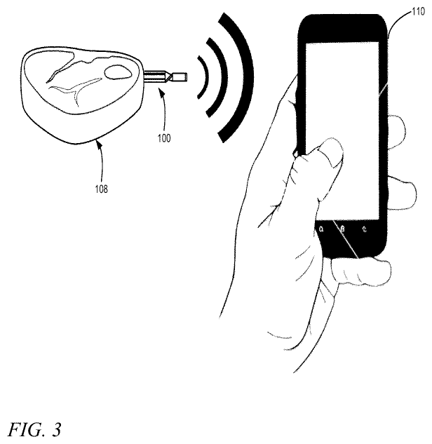

FIG. 3 illustrates wireless communication between the food thermometer 100 and a portable electronic device 110. The thermometer 100 is designed to function wirelessly, transmitting real-time temperature data to the portable electronic device 110 without the need for any wired connections or additional hardware bridges. This allows the thermometer 100 to be conveniently positioned inside a heating vessel (such as an oven or grill), while continuously communicating with the user's portable device.

“Portable electronic device” as used herein refers to an electronic device having at least a processor, a memory, a display, and an antenna for enabling wireless communication. In one embodiment, the portable electronic device is a smartphone (such as an iPhone®) or a tablet computer (such as an iPad®). In other embodiments, the portable electronic device may be a smart watch or other types of smart devices with a processor and an antenna for communicating directly or indirectly with the thermometer.

The thermometer 100 features a unique Trident probe structure, comprising three distinct probes that work together to provide a comprehensive temperature profile of the food 108. The central probe, First Probe 106, is a longer probe inserted into the thickest portion of the food 108 to measure its core temperature. Two shorter probes, Second Probe 104 and Third Probe 102, are symmetrically positioned on either side of the long probe and are responsible for measuring the temperature at the edges of the food. This Trident structure ensures more accurate monitoring of the food's internal and external temperatures, particularly useful for larger cuts of meat where temperature consistency is crucial for even cooking.

In addition to its innovative probe design, the thermometer 100 is equipped with a camera that captures images of the food before the cooking process begins. These images provide the processor 110 with visual feedback on the placement of the Trident probes, as well as the size, shape, and thickness of the food 108. Analyzing these images in combination with real-time temperature data allows the system to offer Artificial Intelligence (AI) cooking adjustments, where the portable electronic device can suggest modifications to the cooking process. The AI uses these inputs to predict the cooking time, recommend adjustments to grill settings, and fine-tune the cooking temperature based on the food's dimensions and specific heat capacity.

Furthermore, this integration of temperature data and visual analysis allows for real-time cooking simulation models, offering the user continuous visual feedback on the progress of the cooking. The AI cooking adjustment system can dynamically adjust grill parameters such as height, angle, and power based on changes in the temperature curve, ensuring precision cooking for optimal results.

Overall, the combination of the Trident probe structure, image capture capabilities, and AI-driven real-time adjustments provides users with a sophisticated, hands-off approach to achieving perfect cooking results, every time.

In another embodiment, the positioned symmetrically on either side of the first probe are the Second Probe 104 and Third Probe 102, both of which are retractable. This retractable feature allows the user to adjust the length of the second and third probes to contact the food's edge at different depths. This capability ensures that the probes can be customized based on the thickness of the food or the specific area being monitored, particularly useful for various cuts of meat.

The adjustable length of the second and third probes enables precise temperature readings at multiple depths, allowing for real-time monitoring of both the food's core and its edges. This design ensures even cooking and provides accurate feedback, particularly when cooking thicker cuts of meat where edge and core temperatures may vary significantly.

### Wireless Communication and Data Processing

The thermometer 100's wireless communication module, located in the third Probe, is essential for real-time data transmission. Using technologies such as Bluetooth or Wi-Fi, the collected temperature data from the central long probe and two shorter probes is transmitted to a connected mobile device.

The mobile application receives and processes this data, displaying the temperature readings from all three probes. The central long probe's data is used to monitor the core temperature of the food, while the shorter side probes provide information about surface and near-surface temperatures. This data allows the user to visually track how heat penetrates the food and to detect any uneven cooking that may be occurring. Additionally, the system can generate real-time alerts and provide cooking recommendations, such as adjusting the heat level or repositioning the food, based on the temperature differentials between the probes.

### Additional Features for Enhanced Cooking Precision

Ambient Temperature Monitoring: The thermometer 100 can also measure the ambient temperature in the cooking vessel (e.g., oven or BBQ) using sensors in the third Probe. This feature allows the system to provide more accurate feedback on how external conditions may be affecting the cooking process, further optimizing the cooking experience.
Real-Time Feedback and Cooking Recommendations: By analyzing the temperature data from the central and side probes, the thermometer 100 can provide real-time feedback. For instance, if the central probe shows a significantly lower temperature than the side probes, the system can recommend adjusting the heat to prevent overcooking the exterior while the core remains under-cooked.
Durability and Safety: The materials used for the thermometer probes are designed to withstand high temperatures. The probes are typically made of heat-resistant materials like stainless steel, ensuring they remain functional during prolonged exposure to heat. Additionally, the electronic components within the first and second Probes are isolated to protect them from heat damage.

### Benefits of the Trident Probe Design

The Trident configuration—with a long central probe and two shorter side probes—offers several advantages over traditional single-probe thermometers:
1) Comprehensive Temperature Monitoring: By measuring the temperature at three different depths (surface, near-surface, and core), users can achieve a more complete understanding of how the food is cooking. This helps prevent common issues like overcooking the outside while the inside remains underdone.
2) Real-Time Alerts and Recommendations: The system provides dynamic feedback during the cooking process, notifying the user when temperature imbalances occur and suggesting corrective actions such as lowering the heat or repositioning the food.
3) Versatility: The design is adaptable to a variety of food types and cooking methods. Whether grilling, roasting, or baking, the Trident probe system ensures that the user can maintain control over the cooking process, achieving consistent and accurate results.

The embodiment of the thermometer 100 with the Trident probe configuration offers a precise, reliable, and user-friendly solution for monitoring food temperature during cooking. The combination of a central long probe and two shorter side probes allows for comprehensive temperature data collection, ensuring even cooking throughout the food. The wireless communication capabilities, combined with real-time feedback and cooking recommendations, provide users with full control over the cooking process, improving food quality and consistency.

This advanced thermometer system is particularly useful for achieving ideal doneness in a wide variety of foods, from thick cuts of meat to delicate dishes. By incorporating innovative technology with practical design, the thermometer 100 offers an optimal solution for both professional chefs and home cooks. Referring to FIG. 1, the thermometer includes at least two probes, a longer central probe and two shorter probes positioned symmetrically on either side of the central probe, forming a shape resembling a “Trident.” The longer central probe is designed to penetrate deeper into the food, measuring the core temperature, while the shorter probes monitor the surface or near-surface temperatures. This configuration allows for comprehensive temperature monitoring across multiple depths within the food.

The “Trident” configuration is particularly useful in meats such as roasts, steaks, or poultry, where the outer layers cook more rapidly than the center. By providing real-time measurements from both the core and surface, the thermometer helps ensure even cooking and better flavor retention.

The thermometer's control system collects temperature data from all probes and processes it into usable data points, including temperature differentials between the different probes. This data is transmitted via the wireless communication module to a paired external device, where it is displayed in a user-friendly interface. The data is often presented in the form of temperature curves, which provide visual representations of how the internal and external temperatures evolve during cooking.

In some embodiments, the control system also uses the temperature differential between the surface and internal probes to assess the evenness of cooking. The system can provide feedback on whether the food is cooking uniformly, whether the heat should be adjusted, or whether the food should be repositioned on the grill or within the oven.

For example, if the images reveal that the probes are not optimally placed or if the temperature data indicates that the internal and external temperatures are not in harmony, the system can suggest adjusting the probe placement, changing the heat source, or extending/reducing the cooking time. This functionality allows users to avoid common problems like overcooking the edges while under-cooking the center.

The present disclosure is designed to provide real-time feedback to the user through an external device, such as a mobile application. The application is configured to display the temperature data from each probe in the form of temperature curves. In addition, the captured images of the food and the placement of the probes are overlaid with the temperature data to provide a comprehensive view of the cooking process. The user interface can alert the user when certain temperature thresholds are reached, indicating that the food needs to be turned, removed, or cooked further to achieve an even doneness.

In some embodiments, the processor uses machine learning algorithms to further enhance feedback accuracy. By analyzing historical cooking data and probe placement information, the system can improve its recommendations over time, tailoring feedback to the user's cooking preferences and the specific characteristics of different types of food.

In another embodiment, each probe is independently calibrated to account for the varying thermal conductivity at different food depths. This calibration ensures that the temperature readings are accurate despite heat gradients. For safety, the system can alert the user if the internal temperature remains too low while the surface temperature is near overcooking levels, reducing the risk of unsafe food consumption.

The present disclosure can be applied in various cooking methods, including grilling, roasting, and baking, where temperature precision is critical for achieving the desired doneness and flavor. Its dual function of monitoring multiple temperature depths and analyzing visual probe placement makes it ideal for both novice and professional cooks seeking to enhance their cooking outcomes. This wireless thermometer is particularly useful for large cuts of meat, where traditional single-point thermometers fail to provide a comprehensive view of the cooking process.

1. A wireless thermometer for measuring food temperatures during a cooking process, the wireless thermometer comprising:
at least two probes of different lengths, each probe configured to measure temperatures at distinct depths of a food item during cooking;
a control system configured to process temperature data indicates the temperatures measured by the probes at different times;
a wireless communication module configured to wirelessly transmit the temperature data.

2. The wireless thermometer of claim 1, wherein the probes include a longer central probe and two shorter probes positioned symmetrically on either side of the longer central probe.

3. The wireless thermometer of claim 2, wherein the shorter probes are configured to measure surface or near-surface temperatures of the food item, while the longer central probe is configured to measure deeper internal temperatures.

4. The wireless thermometer of claim 3, wherein the control system is further configured to collect the temperature differential between the probes, providing feedback on whether the internal and external portions of the food item are cooking evenly.

5. The wireless thermometer of claim 1, further comprising ambient temperature sensors located in a handle portion of the wireless thermometer.

6. A method for monitoring and optimizing food cooking comprising:
Inserting a wireless thermometer comprising at least two temperature probes of varying lengths into different depths of a food item;
capturing temperature data from each probe during the cooking process; and
wirelessly transmitting the temperature data to an external device.

7. The method of claim 6, wherein the wireless thermometer include a longer central probe and two shorter probes positioned symmetrically on either side of the longer central probe, and wherein the method further comprises□
capturing images of the food item and the wireless thermometer's probe placement inserted into the food item;
analyzing physical properties of the food item using the captured images; and
estimating weight, volume, and thickness of the food item, and generating cooking predictions based on the analyzed physical properties.

8. The method of claim 7, wherein the method further comprises:
generating a real-time simulation model of cooking progress,
providing dynamic updates based on the temperature data and the captured images, and
indicating cooking parameters.

9. A food cooking monitoring system comprising:
a wireless food thermometer comprising at least two temperature probes of varying lengths into different depths of a food item;
a portable electronic device configured to receive temperature data from the wireless food thermometer and capture images of the food item and the wireless thermometer's probe placement inserted into the food item; and
an artificial intelligence module within the portable electronic device configured to:
analyze received the temperature data and the captured images;
predict cooking times; and
generate cooking recommendations.

10. The system of claim 9, wherein the wireless thermometer include a longer central probe and two shorter probes positioned symmetrically on either side of the longer central probe, and wherein the artificial intelligence module is further configured to analyze the food item geometry based on the captured images, monitor the temperature data over time, and generate at least one cooking parameter based on the captured images and the temperature data, the cooking parameter being selected from a group consisting of cooking surface angle, cooking surface height, and heating power.

11. The system of claim 9, wherein the portable electronic device further comprises a user interface displaying the temperature data, the captured images, and the cooking recommendations, and an alert mechanism configured to provide notifications based on temperature differentials between the core temperature and the edge temperatures.

12. The system of claim 9, wherein the artificial intelligence module within the portable electronic device is further configured to control at least one cooking parameter based on the captured images and the temperature data.

13. The system of claim 9, wherein the artificial intelligence module within the portable electronic device is trained on a dataset of food types, probe insertion patterns, and cooking methods to generate at least one cooking parameter.
